(19) United States
(12) Patent Application Publication
(10) Pub. No.: US 2012/0112564 A1
(43) Pub. Date: May 10, 2012

(54) Discharging module applied in a switched-mode power supply and method thereof

(76) Inventors: Chin-Ho Wu, Hsin-Chu (TW); Ren-Yi Chen, Hsin-Chu (TW); Chun-Teh Chen, Hsin-Chu (TW)

(21) Appl. No.: 13/092,147

(22) Filed: Apr. 22, 2011

(30) Foreign Application Priority Data
Apr. 22, 2010 (TW) 099112677

(51) Int. Cl. H02H 11/00

(52) U.S. Cl. 307/326

(57) ABSTRACT

A discharging module applied in a switched-mode power supply includes a detecting circuit and a discharging circuit. The detecting circuit is coupled to an input port of the switched-mode power supply. The detecting circuit determines if the input port is supplied power according to an AC input power of the switched-mode power supply. When the detecting circuit determines that the input port is not supplied power, the detecting circuit controls the discharging circuit to provide a discharging path for discharging the input port. In this way, the switched-mode power supply does not require a discharging resistor for discharging the input port. Hence, the power consumed when the switched-mode power supply is unloaded is reduced.

### BACKGROUND OF THE INVENTION

1. Field of the Invention

The present invention relates to a discharging module, and more particularly, to a discharging module applied in a switched-mode power supply.

2. Description of the Prior Art

A switched-mode power supply has an input port for receiving alternating current (AC) input power. The input port of the switched-mode power supply requires an X capacitor for suppressing noise generated due to electromagnetic interference (EMl). A discharging resistor corresponding to the X capacitor is required for avoiding the user getting an electric shock when connection between the input port and the AC input power is broken (for example, when a plug is removed from a socket). However, when the AC input power supplies power normally, the discharging resistor continuously wastes energy, causing unnecessary power consumption.

### SUMMARY OF THE INVENTION

The present invention provides a discharging module applied in a switched-mode power supply. The switched-mode power supply has an input port and a rectifier. The input port is coupled to an AC input power. The rectifier is coupled to the input port for rectifying the AC input power so as to provide a rectified input power to the switched-mode power supply. The discharging module comprises a detecting circuit and a discharging circuit. The detecting circuit is coupled to the input port. The detecting circuit is utilized for determining if the input port is supplied power according to the AC input power. The discharging circuit is controlled by the detecting circuit. The discharging circuit provides a discharging path for discharging the input port when the detecting circuit determines that the input port is not supplied power.

The present invention further provides a discharging method applied to a switched-mode power supply. The switched-mode power supply has an input port and a rectifier. The input port is coupled to an AC input power. The rectifier is coupled to the input port for rectifying the AC input power so as to provide a rectified input power to the switched-mode power supply. The discharging method comprises providing a detecting circuit for determining if the input port is supplied power according to the AC input power, and providing a discharging path for discharging the input port when the detecting circuit determines that the input port is not supplied power.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1, FIG. 2, and FIG. 3 are diagrams illustrating a discharging module according to a first embodiment of the present invention.

FIG. 4 and FIG. 5 are diagrams illustrating a discharging module according to a second embodiment of the present invention.

FIG. 6, FIG. 7, and FIG. 8 are diagrams illustrating a discharging module according to a third embodiment of the present invention.

FIG. 9 is a diagram illustrating a power controller utilizing the discharging module shown in FIG. 6.

### DETAILED DESCRIPTION

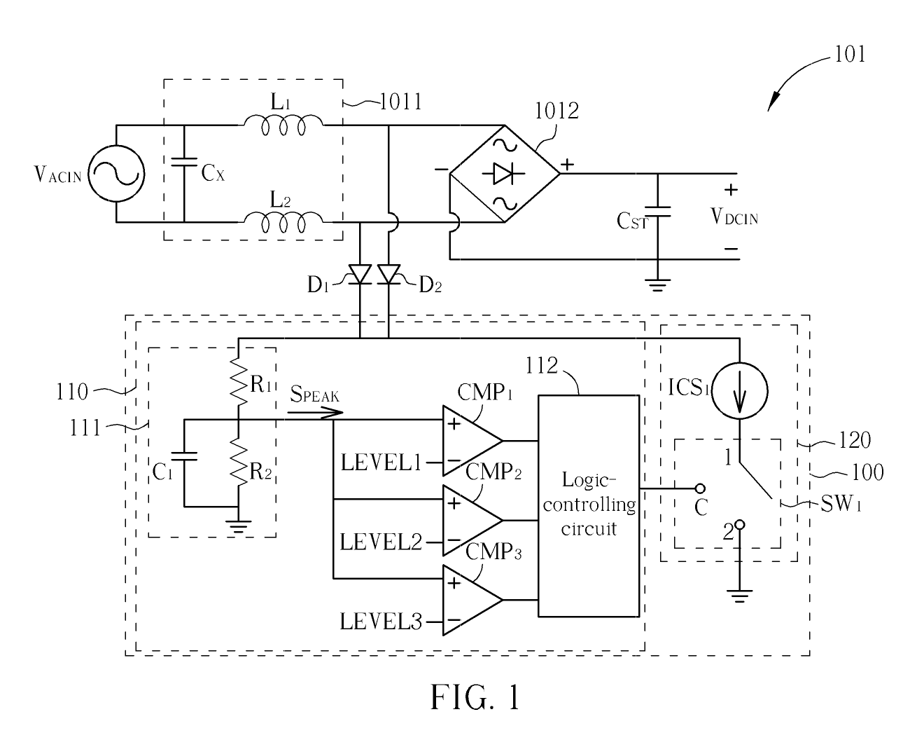

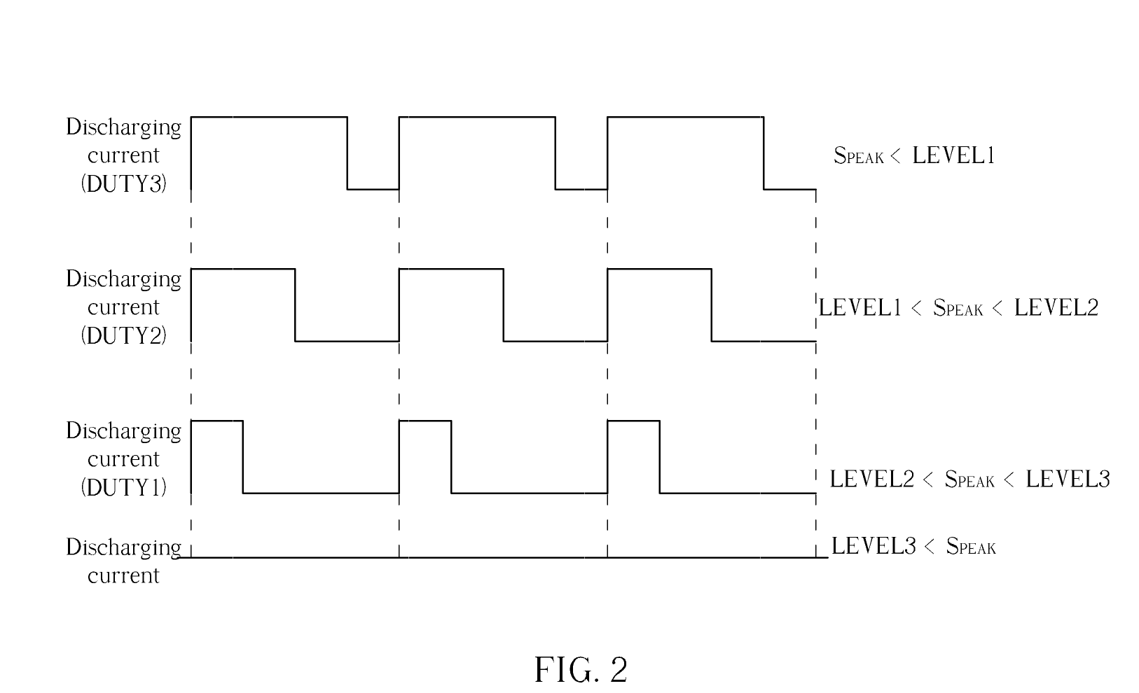

FIG. 1 is a diagram illustrating discharging module 100 according to a first embodiment of the present invention. Discharging module 100 is applied in switched-mode power supply 101. Switched-mode power supply 101 includes input port 1011, rectifier 1012, stabilizing capacitor C_{ST}, and diodes D₁ and D₂. Input port 1011 is coupled to AC input power V_{ACIN}. Input port 1011 includes inductors L₁ and L₂, and X capacitor C_{X}. Inductors L₁ and L₂, and X capacitor C_{X} are utilized for suppressing noise generated due to electromagnetic interference (EMI). Rectifier 1012 is coupled to input port 1011 for rectifying AC input power V_{ACIN} so as to provide rectified input power V_{DCIN} to switched-mode power supply 101. Stabilizing capacitor C_{ST} is utilized for stabilizing voltage provided by rectified input power V_{DCIN}. Diodes D₁ and D₂ further form a full-wave rectifying circuit with two diodes of rectifier 1012. Discharging module 100 includes detecting circuit 110, and discharging circuit 120. Detecting circuit 110 is coupled to input port 1011 for determining if input port 1011 is supplied power according to AC input power V_{ACIN}. More particularly, AC input power V_{ACIN} is rectified by full-wave rectifying circuit formed by diodes D₁ and D₂, and two diodes of rectifier 1012, and then rectified voltage is provided to detecting circuit 110 for detecting circuit 110 to determine if input port 1011 is supplied power. The discharging circuit 120 is controlled by detecting circuit 110. When input port 1011 is determined not to be supplied power (for example, the plug is removed from the socket), detecting circuit 110 controls discharging circuit 120 to provide a discharging path for discharging X capacitor C_{X} of input port 1011. Structures and operational principles of detecting circuit 110 and discharging circuit 120 are further illustrated in the following description.

Detecting circuit 110 includes peak-voltage detector 111, comparators CMP₁, CMP₂, and CMP₃, and logic-controlling circuit 112. Peak-voltage detector 111 detects peak voltage of AC input power V_{ACIN} rectified by full-wave rectifying circuit, and accordingly generates peak-voltage signal S_{PEAK}. Peak-voltage detector 111 includes voltage-dividing circuit (formed by resistors R₁ and R₂), and a capacitor C₁. The operational principle of peak-voltage detector 111 is well known to those skilled in the art, and will be omitted for brevity. Logic-controlling circuit 112 controls discharging circuit 120 to provide a discharging path for discharging X capacitor C_{X} according to the result of comparing peak-voltage signal S_{PEAK} with predetermined values LEVEL1, LEVEL2, and LEVEL3. Discharging circuit 120 includes current source ICS₁, and switch SW₁. Current source ICS₁ is utilized for providing a discharging current. Switch SW₁ is coupled between current source ICS₁ and ground. More particularly, comparators CMP₁, CMP₂, and CMP₃ compare peak-voltage signal S_{PEAK} with predetermined values LEVEL1, LEVEL2, and LEVEL3, respectively. Logic-controlling circuit 112 controls magnitude of discharging current provided by discharging circuit 120 according to signal outputted by comparators CMP₁˜CMP₃. For instance, please refer to FIG. 2. It is assumed that LEVEL1<LEVEL2<LEVEL3. Logic-controlling circuit 112 obtains relationship between peak-voltage signal S_{PEAK} and predetermined values LEVEL1˜LEVEL3 according to signal outputted by comparators CMP₁˜CMP₃. When peak-voltage signal S_{PEAK} is greater than predetermined value LEVEL3, this represents that input port 1011 is supplied power normally. Therefore, logic-controlling circuit 112 controls switch SW₁ to turn off, so that discharging circuit 120 does not discharge input port 1011. When peak-voltage signal S_{PEAK} is between predetermined values LEVEL2 and LEVEL3, logic-controlling circuit 112 controls switch SW₁ to operate with duty cycle DUTY₁. When peak-voltage signal S_{PEAK} is between predetermined values LEVEL1 and LEVEL2, logic-controlling circuit 112 controls switch SW₁ to operate with duty cycle DUTY₂. When peak-voltage signal S_{PEAK} is less than predetermined value LEVEL1, detecting circuit 110 determines that input port 1011 is not supplied power normally. As a result, logic-controlling circuit 112 controls switch SW₁ to operate with duty cycle DUTY₃. According to the discharging method of discharging module 100 illustrated in FIG. 1 and FIG. 2, when peak voltage represented by peak-voltage signal S_{PEAK} goes down, detecting circuit 110 increases period of discharging circuit 120 for discharging X capacitor C_{X}. That is, discharging speed of a discharging path provided by discharging circuit 120 is related to peak voltage of AC input power V_{ACIN}. More specifically, when input port 1011 is not supplied power normally, peak voltage recorded by peak-voltage signal S_{PEAK} gradually goes down. When peak-voltage signal S_{PEAK} is less than predetermined value LEVEL1, discharging module 100 determines input port 1011 is not supplied power, so that switch SW₁ is controlled for discharging circuit 120 to discharge the X capacitor C_{X} with the longest duty cycle. However, discharging module 100 may discharge in advance according to relationship between peak-voltage signal S_{PEAK} and predetermined values LEVEL1˜LEVEL3. In this way, discharging module 100 increases speed of discharging module 100 discharging X capacitor C_{X} when input port 1011 is not supplied power (for instance, the plug is removed from the socket), so that voltage level of voltage across X capacitor C_{X} falls more quickly into a safe range defined by a safety standard. Switched-mode power supply 101 utilizing discharging module 100 does not require an additional discharging resistor for discharging X capacitor Cₓ. In this way, power consumption by the discharging resistor is avoided when switched-mode power supply 101 is not loaded.

FIG. 2 shows that discharging speed can be adjusted by adjusting discharging period of discharging circuit 120. However, discharging speed can also be adjusted by changing magnitude of discharging current. FIG. 3 is a diagram illustrating discharging module 100 adjusting discharging speed by controlling magnitude of discharging current. As shown in FIG. 3, logic-controlling circuit 112 sets magnitude of current of current source ICS₁ as I₁, I₂, or I₃ according to relationship between peak-voltage signal S_{PEAK} and predetermined values LEVEL1˜LEVEL3. When decrease in peak-voltage signal S_{PEAK} is detected, logic-controlling circuit 112 controls discharging circuit 120 to discharge X capacitor C_{X} in advance by current with low magnitude. When input port 1011 is determined not to be supplied power (that is, peak-voltage signal S_{PEAK} is less than predetermined value LEVEL1), logic-controlling circuit 112 controls discharging circuit 120 to discharge X capacitor C_{X} by current with higher magnitude. In this way, speed of discharging module 100 discharging X capacitor C_{X} of input port 1011 is accelerated, so that voltage level of voltage across X capacitor C_{X} falls more quickly into the safe range defined by the safety standard. In addition, discharging module 100 is not limited to having exactly three comparators. Number of comparators is determined according to user requirements. It is possible that discharging module 100 has only one comparator and logic-controlling circuit 112 is omitted in discharging module 100. In this way, although discharging module 100 can not discharge X capacitor C_{X} in advance, discharging module 100 still can discharge X capacitor C_{X} when input port 1011 is determined not to be supplied power.

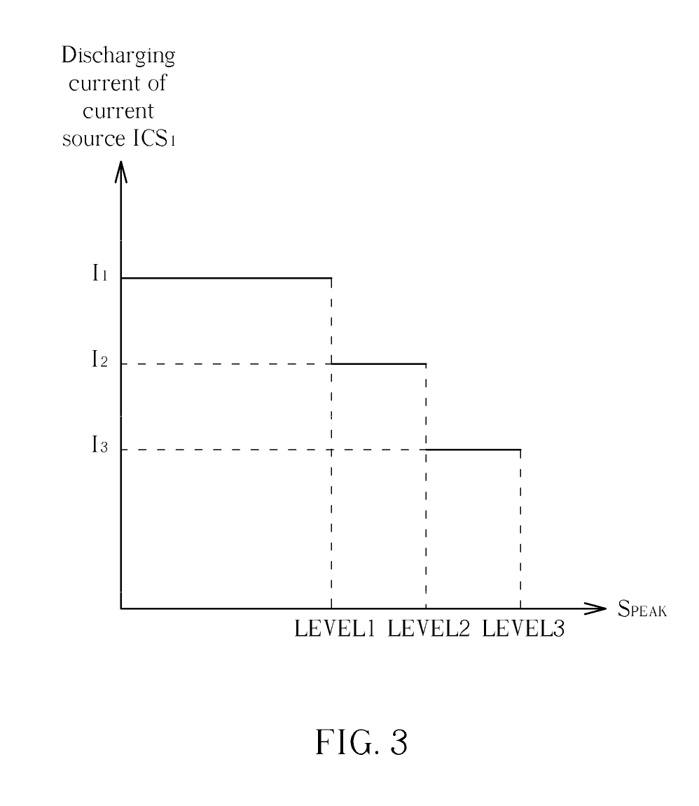

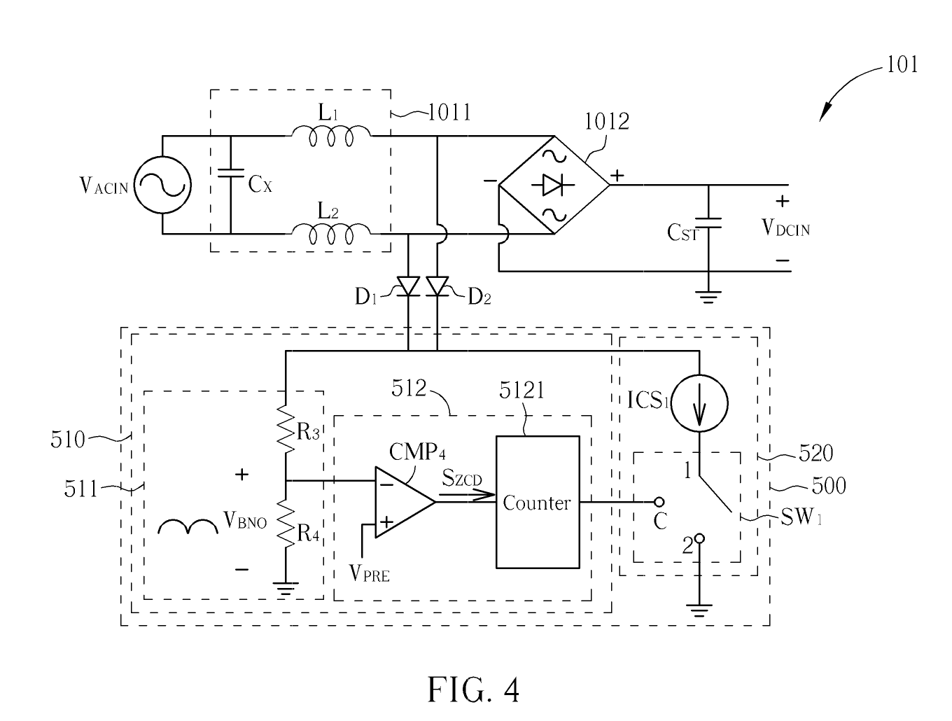

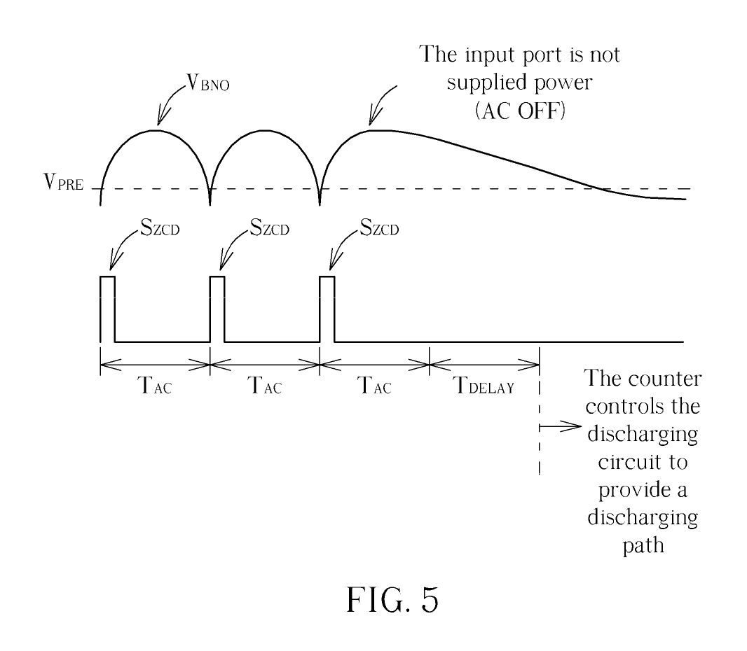

Please refer to FIG. 4 and FIG. 5, which are diagrams illustrating discharging module 500 according to a second embodiment of the present invention. Discharging module 500 includes detecting circuit 510 and discharging circuit 520. The difference between discharging modules 100 and 500 is method of detecting circuit 510 determining if input port 1011 is supplied power. Operational principle and structure of discharging circuit 520 are similar to those of discharging circuit 120, and are omitted for brevity. Detecting circuit 510 includes voltage-dividing circuit 511, and AC detector 512. Voltage-dividing circuit 511 includes resistors R₃ and R₄. Voltage-dividing circuit 511 generates detecting voltage V_{BNO} according to voltage provided by AC input power V_{ACIN} from input port 1011 through full-wave rectifying circuit formed by diodes D₁ and D₂, and two diodes of rectifier 1012. AC detector 512 includes comparator CMP₄ and counter 5121. Comparator CMP₄ is utilized for comparing detecting voltage V_{BNO} and predetermined voltage V_{PRE}. When detecting voltage V_{BNO} is lower than predetermined voltage V_{PRE}, voltage level of AC input power V_{ACIN} is determined to enter a zero crossing zone, and comparator CMP₄ accordingly generates zero crossing signal S_{ZCD}. As shown in FIG. 5, voltage level of AC input power V_{ACIN} enters a zero crossing zone every half AC cycle T_{AC} (for instance, length of an AC cycle is 1/60 second, and length of a half AC cycle T_{AC} is 1/120 second), so that comparator CMP₄ generates zero crossing signal S_{ZCD} every half AC cycle T_{AC}. Therefore, counter 5121 can determine if input port 1011 is supplied power by means of detecting if zero crossing signal S_{ZCD} is continuously generated. If in predetermined period T_{DELAY}, no zero crossing signal S_{ZCD} is generated, counter 5121 determines that input port 1011 is not supplied power. Hence, counter 5121 controls switch SW₁ to turn on so that discharging circuit 520 can provide a discharging path for discharging X capacitor C_{X} of input port 1011.

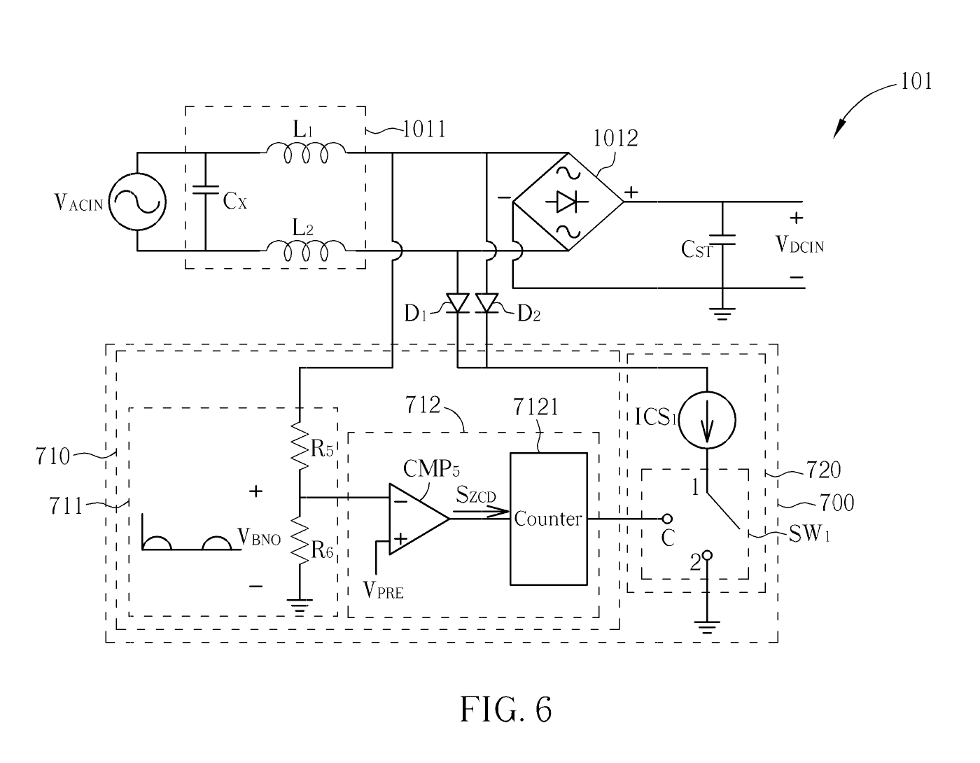

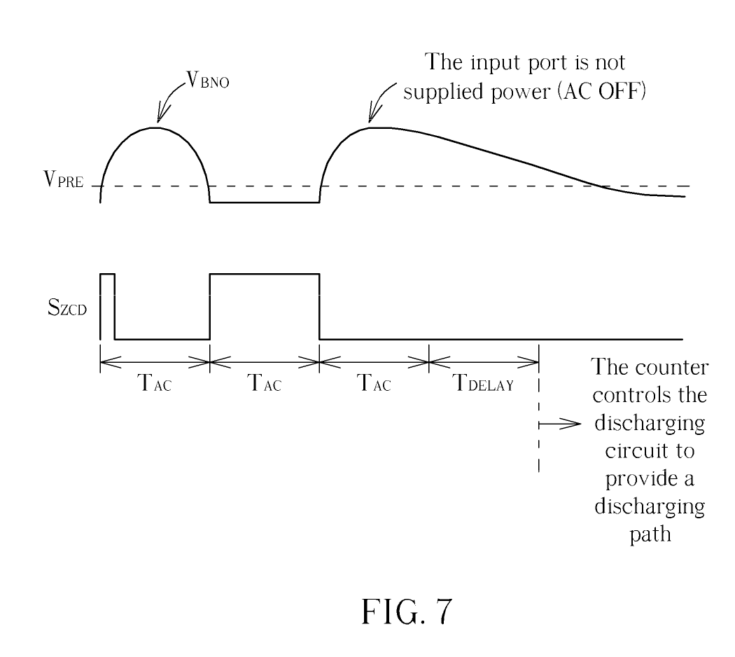

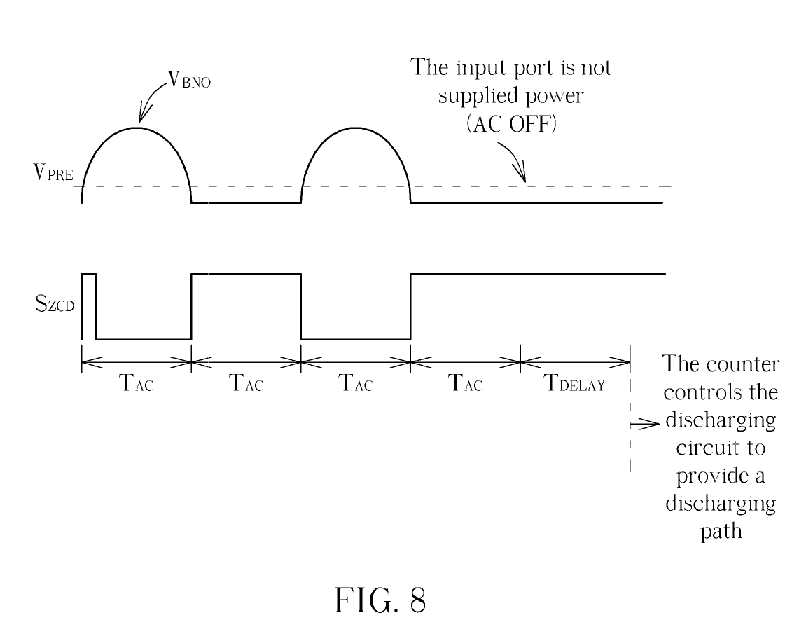

Please refer to FIG. 6, FIG. 7, and FIG. 8, which are diagrams illustrating discharging module 700 according to a third embodiment of the present invention. The difference between discharging modules 500 and 700 is that voltage-dividing circuit 711 and two diodes of rectifier 1012 form a half-wave rectifying circuit coupled to input port 1011. After voltage-dividing circuit 711 receives voltage of AC input power V_{ACIN} rectified by half-wave rectifying circuit, voltage-dividing circuit 711 accordingly generates detecting voltage V_{BNO}. Comparator CMP₅ determines if voltage level of AC input power V_{ACIN} enters a zero crossing zone by means of comparing detecting voltage V_{BNO} with predetermined voltage V_{PRE}, and accordingly generates zero crossing signal S_{ZCD}. FIG. 7 is a diagram illustrating connection between input port 1011 and AC input power V_{ACIN} being broken when detecting voltage V_{BNO} is higher than predetermined voltage V_{PRE}. As shown in FIG. 7, when input port 1011 is not supplied power (AC OFF), zero crossing signal S_{ZCD} generated by comparator CMP₅ remains at low voltage level. FIG. 8 is a diagram illustrating connection between input port 1011 and AC input power V_{ACIN} being broken when detecting voltage V_{BNO} is lower than predetermined voltage V_{PRE}. As shown in FIG. 8, when input port 1011 is not supplied power (AC OFF), zero crossing signal S_{ZCD} generated by comparator CMP₅ remains at high voltage level. Hence, from FIG. 7 and FIG. 8, if logic level of zero crossing signal S_{ZCD} received by counter 7121 does not change for predetermined period T_{DELAY} (that is, voltage level of zero crossing signal S_{ZCD} remains at low or high voltage level for predetermined period T_{DELAY}), detecting circuit 710 can determine input port 1011 is not supplied power and accordingly control discharging circuit 720 to provide the discharge path.

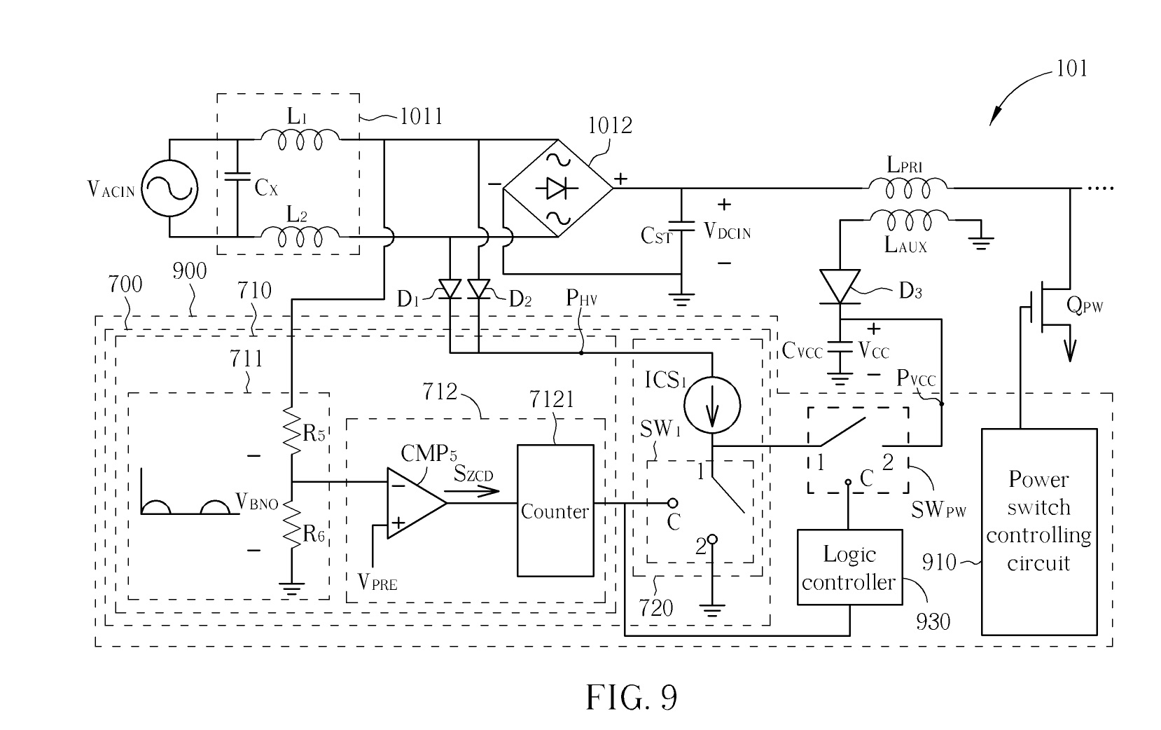

FIG. 9 is a diagram illustrating another embodiment according to discharging module 700 of FIG. 6. Discharging module 700 can be integrated into power controller 900 having a high voltage start-up device. In FIG. 9, L_{PRI} represents the primary winding; L_{AUX} represents the auxiliary winding; and Q_{PW} represents the power switch. Auxiliary winding L_{AUX} is coupled to operational power capacitor C_{VCC} through an auxiliary winding rectifier (such as diode D₃ shown in FIG. 9). In addition to discharging module 700, power controller 900 further includes power switch controlling circuit 910 for controlling power switch Q_{PW}. Power controller 900 is coupled to operational power capacitor C_{VCC} through operational power end P_{VCC}. When power controller 900 is just turned on and operational voltage V_{CC} is not stable yet, by means of turning on power-supplying switch S_{WPW}, high rectified voltage of input power can be utilized for providing a high voltage start-up charging current through high voltage start-up voltage end P_{HV} in a boot period. The high voltage start-up charging current charges operational power capacitor C_{VCC} so that internal power at a lower voltage level can be generated to provide operating voltage of internal circuitry of power controller 900. When power controller 900 is in steady state, end P_{HV} is caused to stop providing high voltage start-up charging current by means of turning off power-supplying switch SW_{PW}. Therefore, power consumption is reduced. In addition, operational power capacitor C_{VCC} is changed to be charged by auxiliary winding L_{AUX}.

In the present embodiment, current source ICS₁ of discharging module 700 is current provided by high voltage start-up device. Detecting circuit 710 can simultaneously control turning on or off of switch SW₁ and power-supplying switch SW_{PW} through logic controller 930. When power controller 900 is just turned on, power-supplying switch SW_{PW} is turned on and switch SW₁ is turned off. High voltage of the input power charges operational power capacitor C_{VCC} through end HV. When power controller 900 is in steady state, power-supplying switch SW_{PW} is turned off for stopping current provided by high voltage start-up device from charging operational power capacitor C_{VCC}. In this way, current provided by high voltage start-up device is only utilized as the current source in discharging circuit 720, and the discharging path is formed based on if switch SW₁ is turned on.

Similarly, power controllers utilizing discharging modules 100 and 500 are provided according to the embodiment shown in FIG. 9. Operational principle and structure of power controller utilizing discharging module 100 (or 500) are similar to those of power controller 900, and are omitted for brevity.

In conclusion, discharging modules applied in switched-mode power supplies are provided. The discharging module includes a detecting circuit, and a discharging circuit. The detecting circuit is coupled to the input port of the switched-mode power supply. The detecting circuit determines if the input port is supplied power according to the AC input power. When the detecting circuit determines the input port is not supplied power, the detecting circuit controls the discharging circuit to provide a discharging path for discharging the input port (the X capacitor). In this way, the switched-mode power supply utilizing the discharging module does not require an additional discharging resistor. Consequently, when the switched-mode power supply is not loaded, the power consumption caused by the discharging resistor is avoided.

Those skilled in the art will readily observe that numerous modifications and alterations of the device and method may be made while retaining the teachings of the invention.

What is claimed is:

1. A discharging module applied in a switched-mode power supply, the switched-mode power supply having an input port and a rectifier, the input port coupled to an alternating current (AC) input power, the rectifier coupled to the input port for rectifying the AC input power so as to provide a rectified input power to the switched-mode power supply, the discharging module comprising:
a detecting circuit, coupled to the input port, for determining if the input port is supplied power according to the AC input power; and
a discharging circuit, controlled by the detecting circuit, for providing a discharging path for discharging the input port when the detecting circuit determines that the input port is not supplied power.

2. The discharging module of claim 1, wherein the switched-mode power supply further comprises an X capacitor, coupled to the AC input power, for suppressing noise generated due to electromagnetic interference (EMl), and the X capacitor is discharged by the discharging circuit when the detecting circuit determines that the input port is not supplied power.

3. The discharging module of claim 1, wherein the rectifier is a full-wave rectifier, coupled between the input port and the detecting circuit, for performing full-wave rectification to the AC input power.

4. The discharging module of claim 1, wherein the rectifier is a half-wave rectifier, coupled between the input port and the detecting circuit, for performing half-wave rectification to the AC input power.

5. The discharging module of claim 1, wherein the detecting circuit further comprises a peak-voltage detector for detecting a peak voltage of the AC input power, and the detecting circuit causes the discharging circuit to provide the discharging path when voltage level of the peak voltage is less than a first predetermined value.

6. The discharging module of claim 5, wherein magnitude of discharging current of the discharging path is related to the peak voltage.

7. The discharging module of claim 1, wherein the detecting circuit further comprises an AC detector for detecting if the AC input power generates AC oscillations, and the detecting circuit causes the discharging circuit to provide the discharging path when the AC input power is determined to stop generating AC oscillations.

8. The discharging module of claim 7, wherein the AC detector comprises:
a comparator for determining if voltage of the AC input power enters a zero crossing zone, and accordingly providing a zero crossing signal; and
a counter for causing the discharging circuit to provide the discharging path when the zero crossing signal is not continuously generated in a predetermined period.

9. The discharging module of claim 1, wherein the switched-mode power supply further comprises:
a power switch supplied power by the rectified input power;
a power controller for controlling the power switch, the power controller having an operational power end connected to an operational power capacitor; and
a high voltage start-up device coupled to the input port, for providing a high voltage start-up charging current in a boot period to charge the operational power capacitor.

10. The discharging module of claim 9, wherein the switched-mode power supply further comprises:
a power-supplying switch coupled between the high voltage start-up device and the operational power capacitor, the power-supplying switch being turned off when the discharging path is provided.

11. The discharging module of claim 10, wherein the switched-mode power supply further comprises:
an auxiliary winding coupled to the operational power capacitor through an auxiliary winding rectifier.

12. A discharging method applied to a switched-mode power supply, the switched-mode power supply having an input port and a rectifier, the input port coupled to an alternating current (AC) input power, the rectifier coupled to the input port for rectifying the AC input power so as to provide a rectified input power to the switched-mode power supply, the discharging method comprising:
providing a detecting circuit for determining if the input port is supplied power according to the AC input power; and
providing a discharging path for discharging the input port when the detecting circuit determines that the input port is not supplied power.

13. The discharging method of claim 12, wherein the switched-mode power supply further comprises an X capacitor coupled to the AC input power for suppressing noise generated due to electromagnetic interference (EMI), and wherein the discharging method comprises:
discharging the X capacitor when the detecting circuit determines that the input port is not supplied power.

14. The discharging method of claim 12, wherein the detecting circuit determining if the input port is supplied power comprises:
performing full-wave rectification to the AC input power to generate a full-wave rectified signal; and
determining if the input port is supplied power according to the full-wave rectified signal.

15. The discharging method of claim 12, wherein the detecting circuit determining if the input port is supplied power comprises:
performing half-wave rectification to the AC input power to generate a half-wave rectified signal; and
determining if the input port is supplied power according to the half-wave rectified signal.

16. The discharging method of claim 12, wherein the detecting circuit determining if the input port is supplied power comprises:
detecting a peak voltage of the AC input power; and
determining the input port is not supplied power when voltage level of the peak voltage is less than a predetermined value.

17. The discharging method of claim 12, wherein the detecting circuit determining if the input port is supplied power comprises:
detecting if the AC input power generates AC oscillations; and
determining the input port is not supplied power when the AC input power is determined not to generate AC oscillations in a predetermined period.

18. The discharging method of claim 17, wherein detecting if the AC input power generates AC oscillations comprises:
determining if voltage of the AC input power enters a zero crossing zone, and accordingly providing a zero crossing signal.

19. The discharging method of claim 17, wherein detecting if the AC input power generates AC oscillation comprises:
determining the input port is not supplied power when the zero crossing signal is not continuously generated in a predetermined period.

20. The discharging method of claim 12, wherein the switched-mode power supply further comprises:
a power switch supplied power by the rectified input power;
a power controller for controlling the power switch, the power controller having an operational power end connected to an operational power capacitor; and
a high voltage start-up device coupled to the input port, for providing a high voltage start-up charging current in a boot period to charge the operational power capacitor through a high voltage start-up end of the power controller;
wherein the discharging path passes through the high voltage start-up device, and the high voltage start-up device does not charge the operational power capacitor after the boot period.
